(19) United States
(12) Patent Application Publication
(10) Pub. No.: US 2023/0262578 A1
(43) Pub. Date: Aug. 17, 2023

(54) Common Interface for Multicast Address Subscriptions

(71) Applicant: Google LLC, Mountain View, CA (US)

(72) Inventors: Pradip S. De, Fremont, CA (US); Jay Dare Logue, San Jose, CA (US)

(73) Assignee: Google LLC, Mountain View, CA (US)

(21) Appl. No.: 18/006,962

(22) PCT Filed: Jul. 29, 2020
(86) PCT No.: PCT/US2020/043983

§ 371 Date: Jan. 26, 2023

(51) Int. Cl. H04W 40/24; H04L 45/16

(52) U.S. Cl. CPC H04W 40/246; H04W 40/248; H04L 45/16; H04W 84/12

(57) ABSTRACT

Techniques and devices for multicast address subscriptions in a wireless mesh network are described in which a mesh network device generates a Multicast Listener Discovery, MLD, Report message including a multicast address. The mesh network device sends the generated MLD Report message to a network interface and a Wireless Personal Area Network, WPAN, Tun interface intercepts the MLD Report message. The mesh network device parses the intercepted MLD Report message to extract the multicast address, translates the intercepted MLD Report message into a mesh network Application Programming Interface, API, function call to join the multicast address, and invokes the API function call on a mesh network interface to transmit a multicast join request message over the mesh network.

### BACKGROUND

Using wireless mesh networking to connect devices to each other, and to cloud-based services, is increasingly popular for sensing environmental conditions, controlling equipment, and providing information and alerts to users. Many devices on wireless mesh networks are designed to operate for extended periods of time on battery-power, which limits the available computing, user interface, and radio resources in the devices. Many devices and applications on wireless mesh networks utilize multicast communications to efficiently communicate information that is published by one node and subscribed to by multiple other nodes in the network.

Additionally, some wireless mesh network devices may include both a mesh network interface and an interface for another network such as Wi-Fi or Ethernet. While the application programming interfaces (APIs) for network interfaces for Wi-Fi or Ethernet may be similar for accessing multicast address subscriptions, the API for accessing multicast address subscriptions using the mesh network interface may be different. When an application is not aware of which network interface to use for accessing multicast address subscriptions, the application is burdened with attempting to join a multicast group over the mesh network interface and over the Wi-Fi or Ethernet interface using the different APIs of the multiple interfaces.

### SUMMARY

This summary is provided to introduce simplified concepts of a common interface for multicast address subscriptions, generally related to joining a multicast address by a device with a mesh network interface and another network interface. The simplified concepts are further described below in the Detailed Description. This summary is not intended to identify essential features of the claimed subject matter, nor is it intended for use in determining the scope of the claimed subject matter.

In aspects, methods, devices, systems, and means for a common interface for multicast address subscriptions in a wireless mesh network are described in which a mesh network device generates a Multicast Listener Discovery (MLD) Report message including a multicast address. An application in the mesh network device sends the generated MLD Report message to a network interface and a Wireless Personal Area Network (WPAN) Tun interface intercepts the MLD Report message. The mesh network device parses the intercepted MLD Report message to extract the multicast address, translates the intercepted MLD Report message into a mesh network Application Programming Interface (API) function call to join the multicast address, and invokes the API function call on a mesh network interface to transmit a multicast join request message over the mesh network.

The details of one or more implementations are set forth in the accompanying drawings and the following description. Other features and advantages will be apparent from the description and drawings and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

Aspects of a common interface for multicast address subscriptions are described with reference to the following drawings. The same numbers are used throughout the drawings to reference like features and components:

FIG. 1 illustrates an example mesh network system in which various aspects of a common interface for multicast address subscriptions can be implemented.

FIG. 2 illustrates an example environment in which various aspects of a common interface for multicast address subscriptions can be implemented.

FIG. 3 illustrates an example mesh network device in which various aspects of the techniques a common interface for multicast address subscriptions can be implemented.

FIG. 4 illustrates an example method of a common interface for multicast address subscriptions as in accordance with aspects of the techniques described herein.

FIG. 5 illustrates an example environment in which a mesh network can be implemented in accordance with aspects of the techniques described herein.

FIG. 6 illustrates an example mesh network device that can be implemented in a mesh network environment in accordance with one or more aspects of the techniques described herein.

FIG. 7 illustrates an example system with an example device that can implement aspects of a common interface for multicast address subscriptions.

### DETAILED DESCRIPTION

This document describes techniques and devices to simplify joining a multicast address (e.g., subscribing to data published from the multicast address) for applications executing on devices in a wireless mesh network. Joining a multicast address over a mesh network may be different from the typical methods used by an application to join a multicast group over other network interfaces, for example Wi-Fi, Ethernet, or the like. This places an burden on the application to be cognizant of whether the application is attempting to join the multicast address on a mesh network interface or a different network interface, or the application may be unaware of which interface provides a route to the multicast address and the application may need to use different application programming interfaces (APIs) for different interfaces in its attempt to join the multicast address.

Wireless mesh networks are communication networks having wireless nodes connected in a mesh topology that provides reliable and redundant communication paths for data traffic within the mesh network. Wireless mesh networks use multiple radio links, or hops, to forward data traffic between devices within the mesh network. This provides coverage for areas larger than the area covered by a single radio link.

Wireless mesh networks can be based on proprietary technologies, or standards-based technologies. For example, wireless mesh networks may be based on the IEEE 802.15.4 standard, which defines physical (PHY) layer and Media Access Control (MAC) layer features and services for use by applications at higher layers of a mesh networking stack. Upper-layer applications rely on these standards-defined services to support addressing and routing of packet data to support application-level communication across a mesh network and between the mesh network and external networks. Similarly, other wireless mesh network technologies, such as Bluetooth®, Thread®, ZigBee®, Z-Wave®, Bluetooth® Low Energy (BLE), Bluetooth Smart, and Bluetooth Mesh have similar layered networking stacks.

Applications at a cloud-based service transmit packets to and receive packets from mesh network devices. These packets traverse a number of networks that use varying technologies. To facilitate low power operation, the mesh network (e.g., a Thread network) uses low-power radio techniques that may use low data rates to conserve energy. Further, mesh network devices may utilize multicast communications to efficiently communicate information that is published by one node and subscribed to by multiple other nodes in the Thread network.

For example, a device (e.g., an application executed by the device) joins a multicast group (multicast address) in a Thread network by invoking APIs that are specific to the Thread network stack. This is different from the standard methods used by a device to join a multicast group over other network interfaces, for example Wi-Fi, Ethernet, or the like.

When a mesh network technology, such as Thread, does not natively support a multicast routing protocol (e.g., Internet Group Management Protocol (IGMP), Multicast Listener Discovery (MLD), or the like) for active querying or reporting of multicast listeners, an application on a mesh network device may need to use a different API for the mesh network interface than the API that is used for other network interfaces. A mesh network device may have both a mesh network (e.g., Thread) interface and a wired or wireless Local Area Network (LAN) interface (e.g., Ethernet, Wireless LAN (WLAN), Wi-Fi, or the like). For example, for an application on a mesh network device running a Linux operating system on its host processor and OpenThread on an IEEE 802.15.4 network co-processor, the application attempts to join a multicast address on the Thread interface by using a Thread-specific API. If the application attempts to join a multicast address on another interface, (e.g., Wi-Fi or Ethernet) then the application would invoke a standard Linux socket option with the appropriate flags using the setsockopt( ) system function with appropriate IPPROTO flags:

struct ipv6_mreq mreq;

setsockopt(sock, IPPROTO_IPV6, IPV6_ADD_MEMBERSHIP, &mreq, sizeof(mreq))

Example System

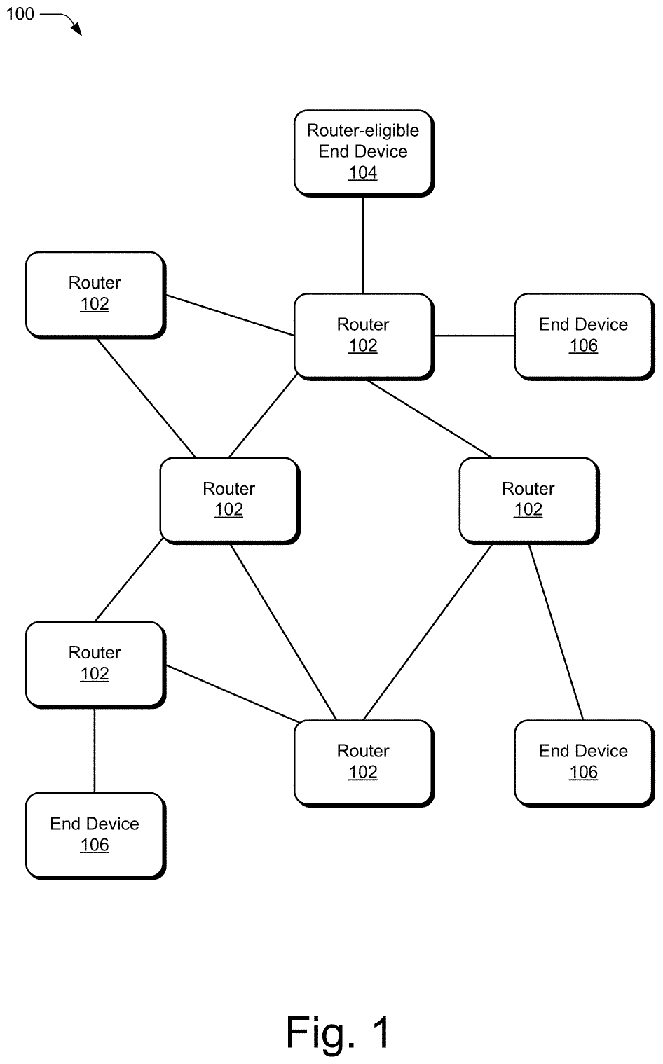

FIG. 1 illustrates an example system as a mesh network 100 in which various aspects of a common interface for multicast address subscriptions can be implemented. The mesh network 100 is a wireless mesh network that includes routers 102, a router-eligible end device 104, and end devices 106. The routers 102, the router-eligible end device 104, and the end devices 106, each include a mesh network interface for communication over the mesh network. The routers 102 receive and transmit packet data over the respective mesh network interfaces. The routers 102 also route traffic across the mesh network 100.

The router-eligible end device 104 is representative of router-eligible end devices that are located at leaf nodes of the mesh network topology and are not actively routing traffic to other nodes in the mesh network 100. The router-eligible device 104 is capable of becoming a router 102 when the router-eligible device 104 is connected to additional mesh network devices. The end devices 106 are devices that can communicate using the mesh network 100, but lack the capability, beyond simply forwarding packets to its parent router 102, to route traffic in the mesh network 100. For example, a battery-powered sensor is one type of end device 106.

Some end devices 106 may power down (e.g., sleep) some operations or hardware for a portion of the time the end device 106 is operational. For example, the end device 106 may power down radios or network interfaces, to conserve power between operations that require a connection to the mesh network 100. For example, a battery-powered temperature sensor may only be awake periodically to transmit a report of temperature, and then the temperature sensor sleeps until the next time the temperature sensor reports. When the end devices 106 sleep, the end devices 106 are not actively connected to the mesh network 100 to respond to address queries or to receive data packets over the mesh network 100.

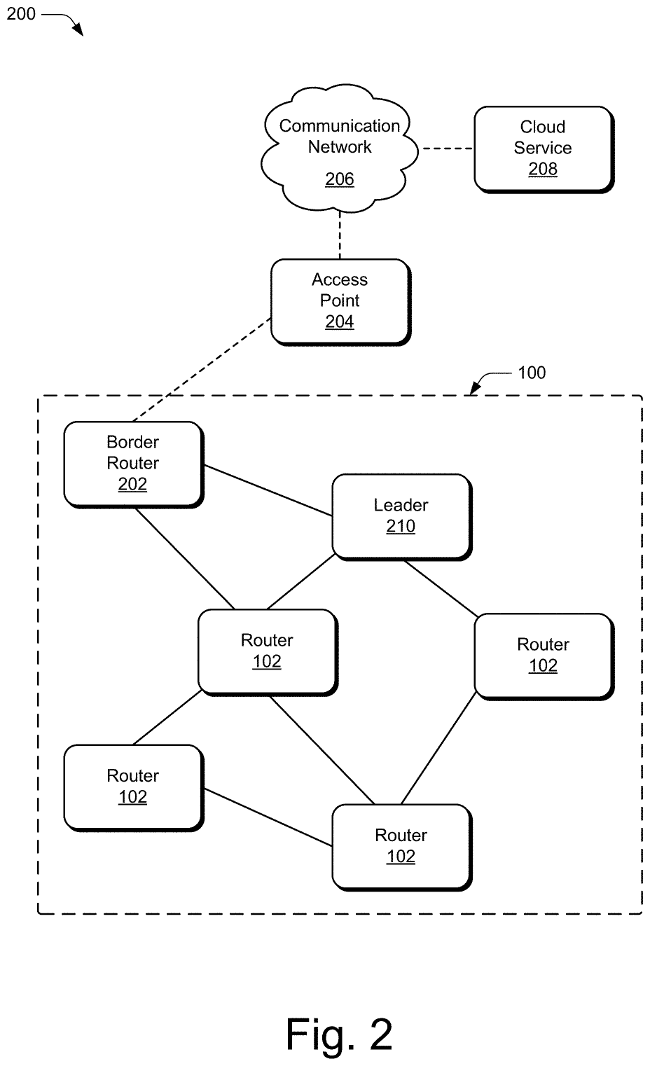

FIG. 2 illustrates an example environment 200 in which various aspects and techniques of a common interface for multicast address subscriptions can be implemented. The environment 200 includes the mesh network 100, in which some routers 102 are performing specific roles in the mesh network 100.

A border router 202 (also known as a gateway and/or an edge router) is one of the routers 102. The border router 202 includes the mesh network interface, as well as a second interface for communication with an external network (e.g., Wi-Fi, Ethernet, or the like), outside the mesh network 100. The border router 202 connects to an access point 204 over the external network. For example, the access point 204 may be an Ethernet router, a Wi-Fi access point, a cellular base station, or any other suitable device for bridging different types of networks. Although a single border router 202 is shown in FIG. 2, for the sake of clarity, the mesh network 100 may have any number of border routers 202, which may connect to any number of external networks. In another implementation, an end device 106 may operate as a border router 202. In this case the end device operating as the border router 202 is routing traffic between the mesh network 100 and an external network, but not routing traffic between other mesh network devices.

The access point 204 connects to a communication network 206, such as the Internet. A cloud service 208, which is connected via the communication network 206, provides services related to and/or using the devices within the mesh network 100. By way of example, and not limitation, the cloud service 208 provides applications that include connecting end user devices, such as smartphones, tablets, and the like, to devices in the mesh network 100, processing and presenting data acquired in the mesh network 100 to end users, linking devices in one or more mesh networks 100 to user accounts of the cloud service 208, provisioning and updating devices in the mesh network 100, and so forth. Alternatively or optionally, services described in relation to the cloud service 208 may be distributed completely or partially between the cloud service 208 and a hub device (e.g., the border router 202, a security hub, or the like) that is installed at the structure where the mesh network devices are installed. The storage location of traits, resources, and interfaces of mesh network devices or structure-related information may be dynamically distributed in any suitable fashion between the cloud service 208 and the hub device.

One of the routers 102 performs the role of a leader 210 for the mesh network 100. The leader 210 manages router identifier assignment, is the central arbiter of network configuration information, and propagates network data, which includes the network configuration information, for the mesh network 100.

Common Interface for Multicast Address Subscriptions

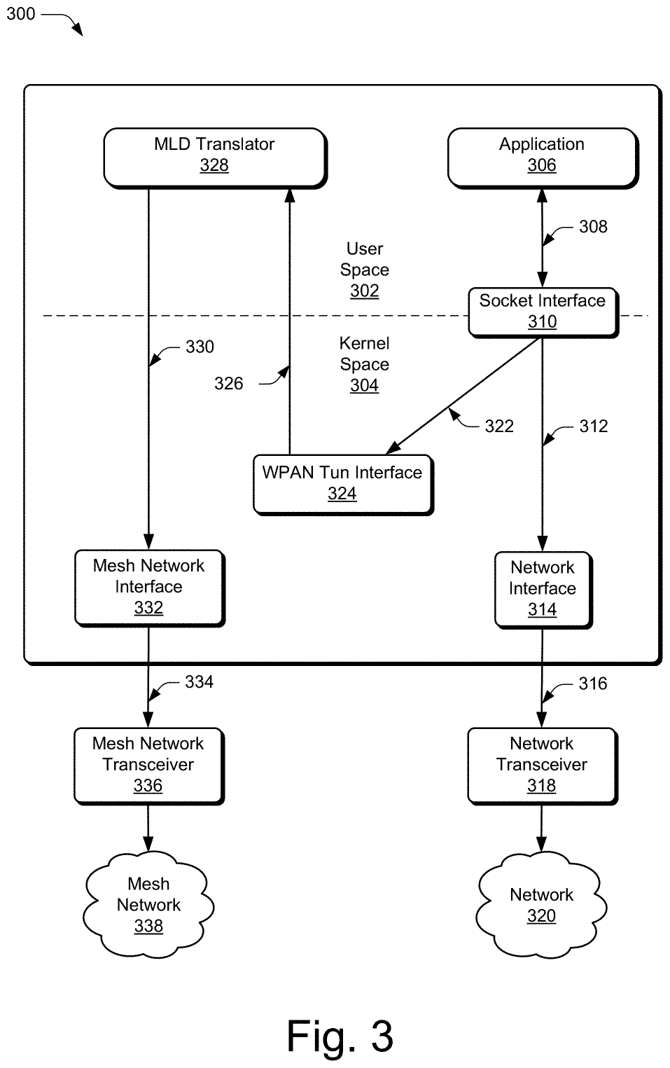

FIG. 3 illustrates an example mesh network device 300 in which various aspects and techniques of a common interface for multicast address subscriptions can be implemented. In aspects, the mesh network device 300 (e.g., a border router 202) includes system memory or other suitable memory divided into a user-space 302 memory and a kernel space 304 memory (the division being illustrated by the dashed lines in FIG. 3), and such that one or more processors included in the mesh network device 300 execute code including user-space code and kernel space (or kernel layer) code.

When an application executing on a mesh network device (e.g., an application running on a Linux-based operating system) attempts to join a multicast address on a network interface, the device sends a Multicast Listener Discovery (MLD) Report message out on the network interface. This message is intended for any MLD router to configure its multicast forwarding cache to forward multicast data packets toward the mesh network device. For example, for a device having a Wi-Fi interface, a multicast join on the Wi-Fi interface would generate MLD Report messages on that Wi-Fi interface.

In one aspect, an application 306 that attempts to join a multicast address (e.g., to subscribe to data published by an application on another device) invokes, at 308, a function of a socket interface 310 to send an MLD Report message to interfaces of the network(s) connected to the mesh network device 300. For example, the application 306 invokes a Linux socket option of the socket interface 310 using the setsockopt( ) system function. The application 306 includes an indication of the multicast address (e.g., an Internet Protocol version 6 (IPv6) address) that the application 306 wants to join as a multicast listener.

At 312, the socket interface 310 sends an MLD Report message to a network interface 314 that the network interface 314 in turn, at 316, forwards as a message to a network transceiver 318 for transmission over a network 320 (e.g., a wired or wireless LAN). For example, the network interface 314 may be an Ethernet interface or a Wi-Fi interface and the network transceiver 318 may be an Ethernet transceiver, or a Wi-Fi transceiver, respectively.

At 322, a Wireless Personal Area Network (WPAN) Tun interface 324 intercepts the MLD Report message sent by the socket interface 310. The WPAN Tun interface 324 resides in the kernel space 304 memory of the mesh network device 300 that continually listens for MLD Report messages destined for other network interfaces. The WPAN Tun interface 324 exposes a virtual tun interface with which the application 306 can interact that enables communication between the application 306 and the mesh network stack.

At 326, the WPAN Tun interface 324 forwards the received MLD Report message to an MLD Translator 328. The MLD Translator 328 parses the MLD Report message to extract a target multicast address and translates the received MDL Report message into a mesh network interface 332 API system function call. In one aspect, the MLD Translator 328 runs in a daemon process (e.g., a WPAN Tun Interface Daemon process, a wpantund daemon process) in the user space 302 memory of the mesh network device 300. For example, the MLD Translator 328 translates the MLD Report message into a Thread API function. At 330, the MLD Translator 328 invokes the mesh network interface API system function (e.g., Thread API function) on the mesh network interface 332 (e.g., a Thread network interface 332) that, in turn, at 334, forwards a mesh network message to a mesh network transceiver 336 for transmission over the mesh network 338.

The WPAN Tun interface 324 and the MLD Translator 328 enable the application 306 to use the same socket options to listen on a multicast address on a mesh network interface as the application 306 would use when listening on a Wi-Fi or Ethernet interface. This approach simplifies the design of the application 306 by providing consistent APIs regardless of the underlying networks supported by the mesh network device 300. The WPAN Tun interface 324 and the MLD Translator 328 enable communication between the application 306 executing on the host operating system of the mesh network device 300 and the Thread network stack running either on a network co-processor or on the host processor.

Example Method

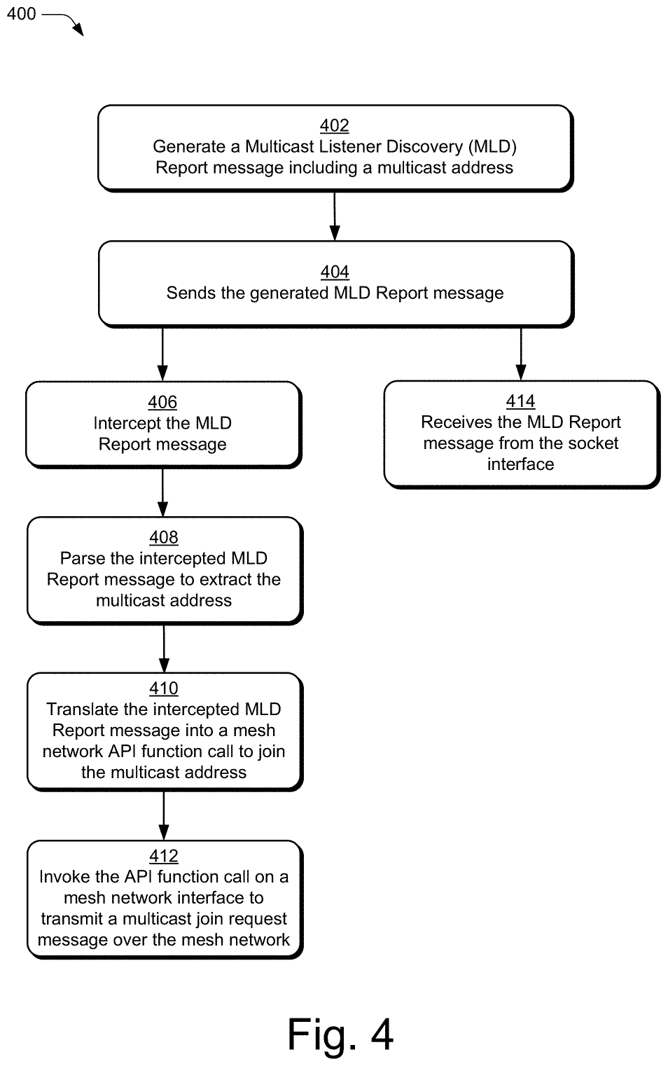

Example method 400 is described with reference to FIG. 4 in accordance with one or more aspects of a common interface for multicast address subscriptions. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

At block 402, a mesh network device generates a Multicast Listener Discovery (MLD) Report message including a multicast address. For example, an application (e.g., the application 306) invokes a socket option of a socket interface (e.g., the socket interface 310), the socket option including a multicast address that the application wants to join. The invocation of the socket option causes the socket interface to generate the MLD Report message for the multicast address.

At block 404, the socket interface sends the generated MLD Report message. For example, the socket interface sends the generated MLD Report to a network interface (e.g., the network interface 314).

At block 406, a Wireless Personal Area Network (WPAN) Tun interface intercepts the MLD Report message. For example, a WPAN Tun interface (e.g., the WPAN Tun interface 324) listens for MLD Report messages from the socket interface, intercepts the MLD Report messages, and forwards the intercepted MLD Report messages to a translator (e.g., the MLD Translator 328).

At block 408, the translator parses the intercepted MLD Report message to extract the multicast address. For example, the MLD Translator 328 parses the intercepted MLD Report message to extract the multicast address that the application 306 want to join.

At block 410, the translator translates the intercepted MLD Report message into a mesh network Application Programming Interface (API) function call to join the multicast address. For example, the MLD Translator 328 uses the multicast address from the intercepted MLD Report to generate an API function call to a mesh network system function to request to join the multicast address.

At block 412, the translator invokes the API function call on a mesh network interface to transmit a multicast join request message over the mesh network. For example, the MLD Translator 328 invokes the API function call on a mesh network interface (e.g., the mesh network interface 332). The API function call on the mesh network interface causes the mesh network interface to use a mesh network transceiver (e.g., the mesh network transceiver 336) to transmit the translated MLD Report message over a mesh network (e.g., the mesh network 338).

At block 414, a network interface receives the MLD Report message from the socket interface. For example, a network interface (e.g., the network interface 314) receives the MLD Report message sent by the socket interface at block 404. Receiving the MLD Report message causes the network interface to use a network transceiver (e.g., the network transceiver 318) to transmit the MLD Report message over a network (e.g., the network 320).

Example Environments and Devices

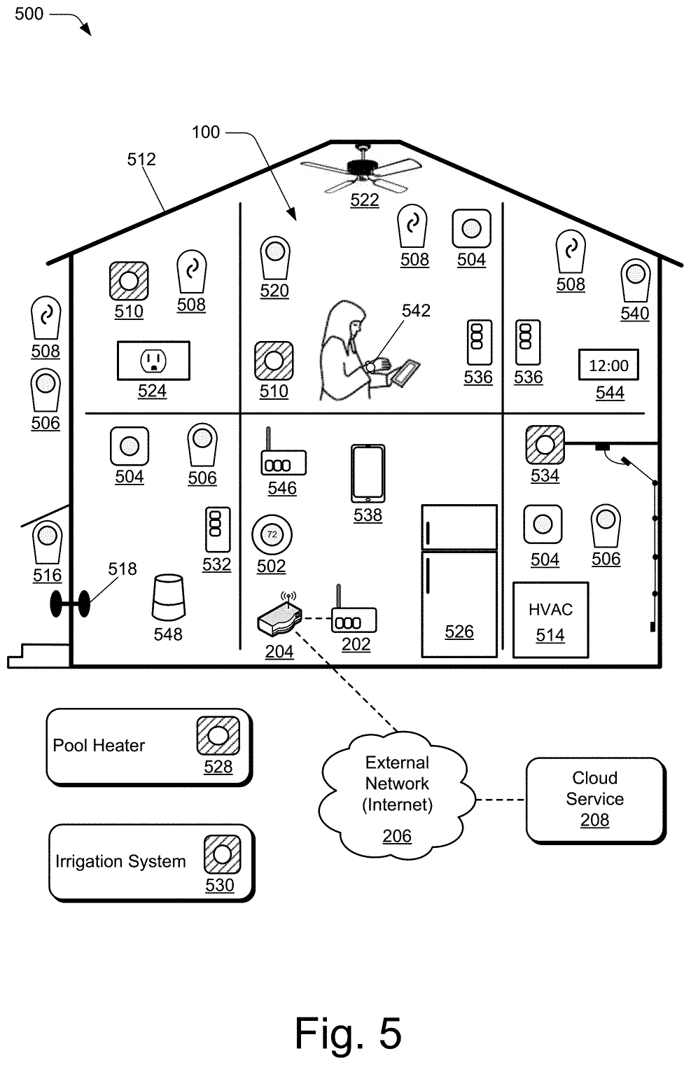

FIG. 5 illustrates an example environment 500 in which the mesh network 100 (as described with reference to FIG. 1), and aspects of a common interface for multicast address subscriptions can be implemented. Generally, the environment 500 includes the mesh network 100 implemented as part of a home or other type of structure with any number of mesh network devices that are configured for communication in a mesh network. For example, the mesh network devices can include a thermostat 502, hazard detectors 504 (e.g., for smoke and/or carbon monoxide), cameras 506 (e.g., indoor and outdoor), lighting units 508 (e.g., indoor and outdoor), and any other types of mesh network devices 510 that are implemented inside and/or outside of a structure 512 (e.g., in a home environment). In this example, the mesh network devices can also include any of the previously described devices, such as a border router 202, as well as any of the devices implemented as a router device 102, and/or as an end device 106.

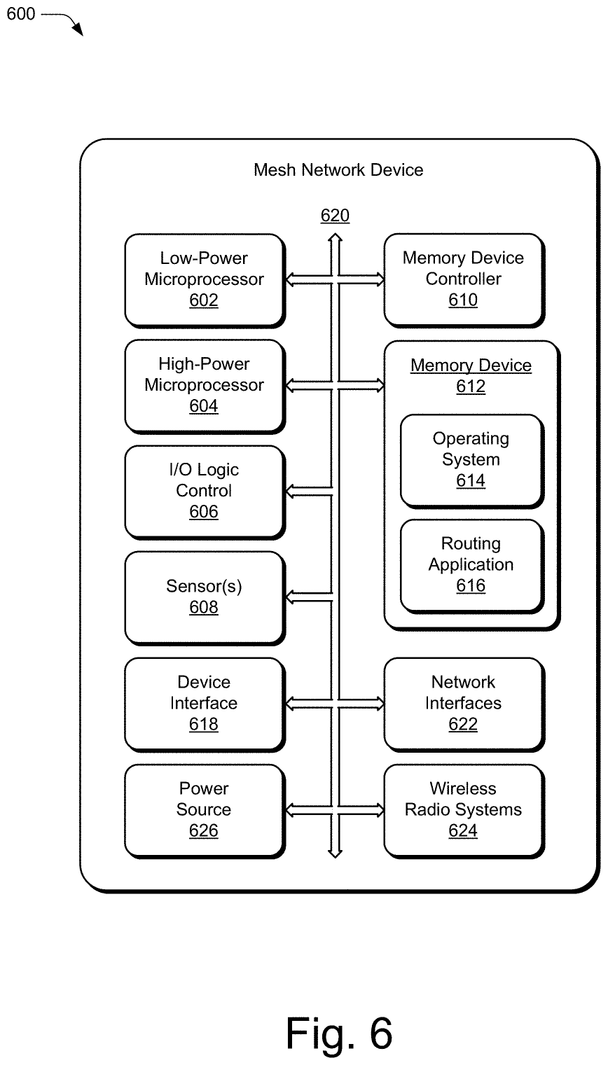

In the environment 500, any number of the mesh network devices can be implemented for wireless interconnection to wirelessly communicate and interact with each other. The mesh network devices are modular, intelligent, multi-sensing, network-connected devices that can integrate seamlessly with each other and/or with a central server or a cloud-computing system to provide any of a variety of useful automation objectives and implementations. An example of a mesh network device that can be implemented as any of the devices described herein is shown and described with reference to FIG. 6.

In implementations, the thermostat 502 may include a Nest® Learning Thermostat that detects ambient climate characteristics (e.g., temperature and/or humidity) and controls a HVAC system 514 in the home environment. The learning thermostat 502 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 504 can be implemented to detect the presence of a hazardous substance or a substance indicative of a hazardous substance (e.g., smoke, fire, or carbon monoxide). In examples of wireless interconnection, a hazard detector 504 may detect the presence of smoke, indicating a fire in the structure, in which case the hazard detector that first detects the smoke can broadcast a low-power wake-up signal to all of the connected mesh network devices. The other hazard detectors 504 can then receive the broadcast wake-up signal and initiate a high-power state for hazard detection and to receive wireless communications of alert messages. Further, the lighting units 508 can receive the broadcast wake-up signal and activate in the region of the detected hazard to illuminate and identify the problem area. In another example, the lighting units 508 may activate in one illumination color to indicate a problem area or region in the structure, such as for a detected fire or break-in, and activate in a different illumination color to indicate safe regions and/or escape routes out of the structure.

In various configurations, the mesh network devices 510 can include an entryway interface device 516 that functions in coordination with a network-connected door lock system 518, and that detects and responds to a person's approach to or departure from a location, such as an outer door of the structure 512. The entryway interface device 516 can interact with the other mesh network devices based on whether someone has approached or entered the smart-home environment. An entryway interface device 516 can control doorbell functionality, announce the approach or departure of a person via audio or visual means, and control settings on a security system, such as to activate or deactivate the security system when occupants come and go. The mesh network devices 510 can also include other sensors and detectors, such as to detect ambient lighting conditions, detect room-occupancy states (e.g., with an occupancy sensor 520), and control a power and/or dim state of one or more lights. In some instances, the sensors and/or detectors may also control a power state or speed of a fan, such as a ceiling fan 522. Further, the sensors and/or detectors may detect occupancy in a room or enclosure and control the supply of power to electrical outlets or devices 524, such as if a room or the structure is unoccupied.

The mesh network devices 510 may also include connected appliances and/or controlled systems 526, such as refrigerators, stoves and ovens, washers, dryers, air conditioners, pool heaters 528, irrigation systems 530, security systems 532, and so forth, as well as other electronic and computing devices, such as televisions, entertainment systems, computers, intercom systems, garage-door openers 534, ceiling fans 522, control panels 536, and the like. When plugged in, an appliance, device, or system can announce itself to the mesh network as described above and can be automatically integrated with the controls and devices of the mesh network, such as in the home. It should be noted that the mesh network devices 510 may include devices physically located outside of the structure, but within wireless communication range, such as a device controlling a swimming pool heater 528 or an irrigation system 530.

As described above, the mesh network 100 includes a border router 202 that interfaces for communication with an external network, outside the mesh network 100. The border router 202 connects to an access point 204, which connects to the communication network 206, such as the Internet. A cloud service 208, which is connected via the communication network 206, provides services related to and/or using the devices within the mesh network 100. By way of example, the cloud service 208 can include applications for connecting end user devices 538, such as smartphones, tablets, and the like, to devices in the mesh network, processing and presenting data acquired in the mesh network 100 to end users, linking devices in one or more mesh networks 100 to user accounts of the cloud service 208, provisioning and updating devices in the mesh network 100, and so forth. For example, a user can control the thermostat 502 and other mesh network devices in the home environment using a network-connected computer or portable device, such as a mobile phone or tablet device. Further, the mesh network devices can communicate information to any central server or cloud-computing system via the border router 202 and the access point 204. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, etc.).

Any of the mesh network devices in the mesh network 100 can serve as low-power and communication nodes to create the mesh network 100 in the home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the mesh network. The mesh network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 540 detects that the room is dark and when the occupancy sensor 520 detects that someone is in the room. Further, the sensor can include a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the mesh network, from node to node (i.e., network-connected device to network-connected device) within the home environment as well as over the Internet to a central server or cloud-computing system.

In other configurations, various ones of the mesh network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the mesh network. In other implementations, the mesh network can be used to automatically turn on and off the lighting units 608 as a person transitions from room to room in the structure. For example, the mesh network devices can detect the person's movement through the structure and communicate corresponding messages via the nodes of the mesh network. Using the messages that indicate which rooms are occupied, other mesh network devices that receive the messages can activate and/or deactivate accordingly. As referred to above, the mesh network can also be utilized to provide exit lighting in the event of an emergency, such as by turning on the appropriate lighting units 508 that lead to a safe exit. The light units 508 may also be turned-on to indicate the direction along an exit route that a person should travel to safely exit the structure.

The various mesh network devices may also be implemented to integrate and communicate with wearable computing devices 542, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other mesh network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the mesh network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the mesh network, conforming to the wireless interconnection protocols for communicating on the mesh network.

The mesh network devices 510 may also include a network-connected alarm clock 544 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the mesh network based on a unique signature of the person, which is determined based on data obtained from sensors located in the mesh network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 502 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other mesh network devices can use the data to provide other automation objectives, such as adjusting the thermostat 502 so as to pre-heat or cool the environment to a desired setting and turning-on or turning-off the lights 508.

In implementations, the mesh network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the mesh network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 500 may include one or more mesh network devices that function as a hub 546. The hub 546 may be a general-purpose home automation hub, or an application-specific hub, such as a security hub, an energy management hub, an HVAC hub, and so forth. The functionality of a hub 546 may also be integrated into any mesh network device, such as a network-connected thermostat device or the border router 202. Hosting functionality on the hub 546 in the structure 512 can improve reliability when the user's internet connection is unreliable, can reduce latency of operations that would normally have to connect to the cloud service 208, and can satisfy system and regulatory constraints around local access between mesh network devices.

Additionally, the example environment 500 includes a network-connected-speaker 548. The network-connected speaker 548 provides voice assistant services that include providing voice control of network-connected devices. The functions of the hub 546 may be hosted in the network-connected speaker 548. The network-connected speaker 548 can be configured to communicate via the mesh network, Wi-Fi, or both.

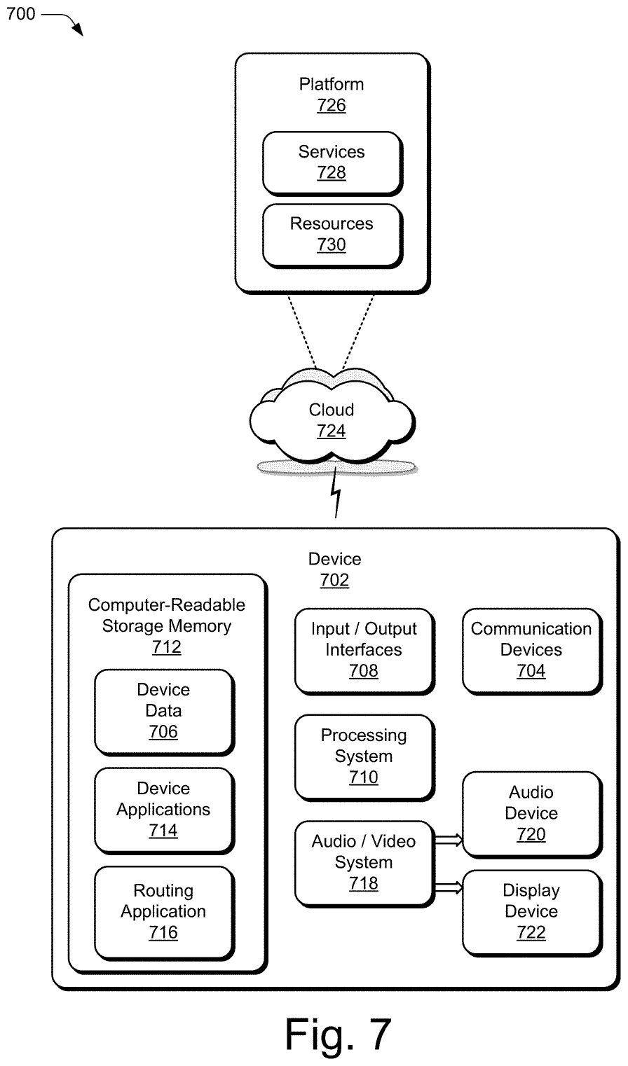

FIG. 6 illustrates an example mesh network device 600 that can be implemented as any of the mesh network devices in a mesh network in accordance with one or more aspects of a common interface for multicast address subscriptions as described herein. The device 600 can be integrated with electronic circuitry, microprocessors, memory, input output (I/O) logic control, communication interfaces and components, as well as other hardware, firmware, and/or software to implement the device in a mesh network. Further, the mesh network device 600 can be implemented with various components, such as with any number and combination of different components as further described with reference to the example device shown in FIG. 7.

In this example, the mesh network device 600 includes a low-power microprocessor 602 and a high-power microprocessor 604 (e.g., microcontrollers or digital signal processors) that process executable instructions. The device also includes an input-output (I/O) logic control 606 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 602 and the high-power microprocessor 604 can also support one or more different device functionalities of the device. For example, the high-power microprocessor 604 may execute computationally intensive operations, whereas the low-power microprocessor 602 may manage less-complex processes such as detecting a hazard or temperature from one or more sensors 608. The low-power processor 602 may also wake or initialize the high-power processor 604 for computationally intensive processes.

The one or more sensors 608 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 608 may include any one or a combination of temperature sensors, humidity sensors, hazard-related sensors, other environmental sensors, accelerometers, microphones, optical sensors up to and including cameras (e.g., charged coupled-device or video cameras, active or passive radiation sensors, GPS receivers, and radio frequency identification detectors. In implementations, the mesh network device 600 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The mesh network device 600 includes a memory device controller 610 and a memory device 612, such as any type of a nonvolatile memory and/or other suitable electronic data storage device. The mesh network device 600 can also include various firmware and/or software, such as an operating system 614 that is maintained as computer executable instructions by the memory and executed by a microprocessor. The device software may also include a routing application 616 that implements aspects of common interface for multicast address subscriptions. The mesh network device 600 also includes a device interface 618 to interface with another device or peripheral component and includes an integrated data bus 620 that couples the various components of the mesh network device for data communication between the components. The data bus in the mesh network device may also be implemented as any one or a combination of different bus structures and/or bus architectures.

The device interface 618 may receive input from a user and/or provide information to the user (e.g., as a user interface), and a received input can be used to determine a setting. The device interface 618 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 618 may also receive inputs from any number of peripherals, such as buttons, a keypad, a switch, a microphone, and an imager (e.g., a camera device).

The mesh network device 600 can include network interfaces 622, such as a mesh network interface for communication with other mesh network devices in a mesh network, and an external network interface for network communication, such as via the Internet. The mesh network device 600 also includes wireless radio systems 624 for wireless communication with other mesh network devices via the mesh network interface and for multiple, different wireless communications systems. The wireless radio systems 624 may include Wi-Fi, Bluetooth™, Mobile Broadband, BLE, and/or point-to-point IEEE 802.15.4. Each of the different radio systems can include a radio device, antenna, and chipset that is implemented for a particular wireless communications technology. The mesh network device 600 also includes a power source 626, such as a battery and/or to connect the device to line voltage. An AC power source may also be used to charge the battery of the device.

FIG. 7 illustrates an example system 700 that includes an example device 702, which can be implemented as any of the mesh network devices that implement aspects of a common interface for multicast address subscriptions as described with reference to the previous FIGS. 1-6. The example device 702 may be any type of computing device, client device, mobile phone, tablet, communication, entertainment, gaming, media playback, and/or other type of device. Further, the example device 702 may be implemented as any other type of mesh network device that is configured for communication on a mesh network, such as a thermostat, hazard detector, camera, light unit, commissioning device, router, border router, joiner router, joining device, end device, leader, access point, and/or other mesh network devices.

The device 702 includes communication devices 704 that enable wired and/or wireless communication of device data 706, such as data that is communicated between the devices in a mesh network, data that is being received, data scheduled for broadcast, data packets of the data, data that is synched between the devices, etc. The device data can include any type of communication data, as well as audio, video, and/or image data that is generated by applications executing on the device. The communication devices 704 can also include transceivers for cellular phone communication and/or for network data communication.

The device 702 also includes input/output (I/O) interfaces 708, such as data network interfaces that provide connection and/or communication links between the device, data networks (e.g., a mesh network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 702 includes a processing system 710 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 702 may further include any type of a system bus or other data and command transfer system that couples the various components within the device. A system bus can include any one or combination of different bus structures and architectures, as well as control and data lines.

The device 702 also includes computer-readable storage memory 712, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 712 provides storage of the device data 706 and various device applications 714, such as an operating system that is maintained as a software application with the computer-readable storage memory and executed by the processing system 710. The device applications may also include a device manager, such as any form of a control application, software application, signal processing and control module, code that is native to a particular device, a hardware abstraction layer for a particular device, and so on. In this example, the device applications also include a routing application 716 that implements aspects of common interface for multicast address subscriptions, such as when the example device 702 is implemented as any of the mesh network devices described herein.

The device 702 also includes an audio and/or video system 718 that generates audio data for an audio device 720 and/or generates display data for a display device 722. The audio device and/or the display device include any devices that process, display, and/or otherwise render audio, video, display, and/or image data, such as the image content of a digital photo. In implementations, the audio device and/or the display device are integrated components of the example device 702. Alternatively, the audio device and/or the display device are external, peripheral components to the example device. In aspects, at least part of the techniques described for common interface for multicast address subscriptions may be implemented in a distributed system, such as over a “cloud” 724 in a platform 726. The cloud 724 includes and/or is representative of the platform 726 for services 728 and/or resources 730.

The platform 726 abstracts underlying functionality of hardware, such as server devices (e.g., included in the services 728) and/or software resources (e.g., included as the resources 730), and connects the example device 702 with other devices, servers, etc. The resources 730 may also include applications and/or data that can be utilized while computer processing is executed on servers that are remote from the example device 702. Additionally, the services 728 and/or the resources 730 may facilitate subscriber network services, such as over the Internet, a cellular network, or Wi-Fi network. The platform 726 may also serve to abstract and scale resources to service a demand for the resources 730 that are implemented via the platform, such as in an interconnected device aspect with functionality distributed throughout the system 700. For example, the functionality may be implemented in part at the example device 702 as well as via the platform 726 that abstracts the functionality of the cloud 724.

In the following some examples are described:

Example 1: A method for joining a multicast address by a mesh network device, the method comprising:

generating a Multicast Listener Discovery, MLD, Report message including the multicast address;

sending, by a socket interface, the generated MLD Report message to a network interface;

intercepting the MLD Report message by a Wireless Personal Area Network, WPAN, Tun interface;

parsing the intercepted MLD Report message to extract the multicast address;

translating the intercepted MLD Report message into a mesh network Application Programming Interface, API, function call, the API function call to join the multicast address; and

invoking the API function call on a mesh network interface to transmit a multicast join request message over the mesh network.

Example 2: The method of example 1, wherein the sending the MLD Report message to the network interface is effective to cause the network interface to send the MLD Report messages over a network.
Example 3: The method of example 2, wherein the network interface is an Ethernet interface and wherein the network is an Ethernet network.
Example 4: The method of example 2, wherein the network interface is a Wi-Fi interface and wherein the network is a Wi-Fi network.
Example 5: The method of any of the preceding examples, wherein the generating the MLD report message comprises:

an application invoking a socket option at the socket interface, the application including the multicast address in the socket option.

Example 6: The method of example 5, wherein the socket interface is a Linux socket interface.
Example 7: The method of any of the preceding examples, wherein the mesh network interface is a Thread interface.
Example 8: A mesh network device comprising:

a mesh network interface;

a network interface;

a processor; and

memory comprising instructions executable by the processor that configure the mesh network device to:
generate a Multicast Listener Discovery, MLD, Report message including a multicast address;
send, by a socket interface, the MLD Report message to the network interface;
intercept the MLD Report message by a Wireless Personal Area Network, WPAN, Tun interface;
parse the intercepted MLD Report message to extract the multicast address;
translate the intercepted MLD Report message into a mesh network Application Programming Interface, API, function call, the API function call to join the multicast address; and
invoke the API function call on a mesh network interface to transmit a multicast join request message over the mesh network.
   Example 9: The mesh network device of example 8, wherein the instructions to generate the MLD Report message is effective to cause the network interface to send the MLD Report messages over a network.
   Example 10: The mesh network device of example 9, wherein the network interface is an Ethernet interface and wherein the network is an Ethernet network.
   Example 11: The mesh network device of example 9, wherein the network interface is a Wi-Fi interface and wherein the network is a Wi-Fi network.
   Example 12: The mesh network device of any of examples 8 to 11, wherein the instructions to generate the MLD report message configure the mesh network device to:
   invoke, by an application, a socket option at the socket interface, the application including the multicast address in the socket option.
   Example 13: The mesh network device of example 12, wherein the socket interface is a Linux socket interface.
   Example 14: The mesh network device of any of examples 8 to 13, wherein the mesh network interface is a Thread interface.
   Example 15: A computer-readable medium comprising instructions that, when executed by a processor, cause an apparatus comprising the processor to perform any of the methods of examples 1 to 7.

Although aspects of a common interface for multicast address subscriptions have been described in language specific to features and/or methods, the subject of the appended claims is not necessarily limited to the specific features or methods described. Rather, the specific features and methods are disclosed as example implementations of a common interface for multicast address subscriptions, and other equivalent features and methods are intended to be within the scope of the appended claims. Further, various different aspects are described, and it is to be appreciated that each described aspect can be implemented independently or in connection with one or more other described aspects.

1. A method for joining a multicast address by a mesh network device, the method comprising:
generating a Multicast Listener Discovery, MLD, Report message including the multicast address;
sending, by a socket interface, the generated MLD Report message to a network interface;
intercepting the MLD Report message by a Wireless Personal Area Network, WPAN, Tun interface;
parsing the intercepted MLD Report message to extract the multicast address;
translating the intercepted MLD Report message into a mesh network Application Programming Interface, API, function call, the API function call to join the multicast address; and
invoking the API function call on a mesh network interface to transmit a multicast join request message over the mesh network.

2. The method of claim 1, wherein the sending the MLD Report message to the network interface is effective to cause the network interface to send the MLD Report messages over a network.

3. The method of claim 2, wherein the network interface is an Ethernet interface and wherein the network is an Ethernet network.

4. The method of claim 2, wherein the network interface is a Wi-Fi interface and wherein the network is a Wi-Fi network.

5. The method of claim 1, wherein the generating the MLD report message comprises:
an application invoking a socket option at the socket interface, the application including the multicast address in the socket option.

6. The method of claim 5, wherein the socket interface is a Linux socket interface.

7. The method of claim 1, wherein the mesh network interface is a Thread interface.

8. A mesh network device comprising:
a mesh network interface;
a network interface;
a processor; and
memory comprising instructions executable by the processor that configure the mesh network device to:
generate a Multicast Listener Discovery, MLD, Report message including a multicast address;
send, by a socket interface, the MLD Report message to the network interface;
intercept the MLD Report message by a Wireless Personal Area Network, WPAN, Tun interface;
parse the intercepted MLD Report message to extract the multicast address;
translate the intercepted MLD Report message into a mesh network Application Programming Interface, API, function call, the API function call to join the multicast address; and
invoke the API function call on a mesh network interface to transmit a multicast join request message over the mesh network.

9. The mesh network device of claim 8, wherein the instructions to generate the MLD Report message are effective to cause the network interface to send the MLD Report messages over a network.

10. The mesh network device of claim 9, wherein the network interface is an Ethernet interface and wherein the network is an Ethernet network.

11. The mesh network device of claim 9, wherein the network interface is a Wi-Fi interface and wherein the network is a Wi-Fi network.

12. The mesh network device of claim 8, wherein the instructions to generate the MLD report message configure the mesh network device to:
invoke, by an application, a socket option at the socket interface, the application including the multicast address in the socket option.

13. The mesh network device of claim 12, wherein the socket interface is a Linux socket interface.

14. The mesh network device of claim 8, wherein the mesh network interface is a Thread interface.

15. A computer-readable medium comprising instructions that, when executed by a processor, cause an apparatus comprising the processor to:
generate a Multicast Listener Discovery, MLD, Report message including a multicast address;
send, by a socket interface, the MLD Report message to a network interface;
intercept the MLD Report message by a Wireless Personal Area Network, WPAN, Tun interface;
parse the intercepted MLD Report message to extract the multicast address;
translate the intercepted MLD Report message into a mesh network Application Programming Interface, API, function call, the API function call to join the multicast address; and
invoke the API function call on a mesh network interface to transmit a multicast join request message over the mesh network.

16. The computer-readable medium of claim 15, wherein the instructions to generate the MLD Report message are effective to cause the network interface to send the MLD Report messages over a network.

17. The computer-readable medium of claim 16, wherein the network interface is an Ethernet interface and wherein the network is an Ethernet network.

18. The computer-readable medium of claim 16, wherein the network interface is a Wi-Fi interface and wherein the network is a Wi-Fi network.

19. The computer-readable medium of claim 15, wherein the instructions to generate the MLD report message cause the apparatus to:
invoke, by an application, a socket option at the socket interface, the application including the multicast address in the socket option.

20. The computer-readable medium of claim 15, wherein the socket interface is a Linux socket interface and wherein the mesh network interface is a Thread interface.
